(19) United States
(12) Patent Application Publication
(10) Pub. No.: US 2003/0047840 A1
(43) Pub. Date: Mar. 13, 2003

(54) Method and apparatus for combining a foundry with a cementatious block plant

(76) Inventor: Michael B. Kelly, Troup, TX (US)

Correspondence Address: Theodore Stevenson, III, McKool Smith P.C., Suite 1500, 300 Crescent Court, Dallas, TX, 75201, US

(21) Appl. No.: 10/228,724

(22) Filed: Aug. 26, 2002

Related U.S. Application Data
(60) Provisional application No. 60/315,162, filed on Aug. 27, 2001.

(51) Int. Cl. B28B 3/00

(52) U.S. Cl. 264/333

(57) ABSTRACT

The present invention pertains to a method and apparatus for combining a foundry with a cementations product plant. The spent foundry sand and core butts can be used by the cementatious product plant as aggregate material in manufacturing cementatious products, such a blocks and pavers. This has the advantages of reducing the cost of the aggregate and reducing or eliminating disposal costs for the spend foundry sand.

### CROSS REFERENCE TO RELATED APPLICATIONS

This Application claims the benefit of the Provisional Application No. 60/315,162, which was filed on Aug. 27, 2001 in the name of Michael B. Kelly, pursuant to 35 U.S.C. §119(e).

### BACKGROUND OF THE INVENTION

1. Background of the Art

Cementatious products can consist of hollow blocks, solid blocks, floor fillers, pavers, architectural products, and other products. Cementatious products are less expensive to manufacture than clay brick, which requires high temperatures. In contrast, cementatious products are produced using a molding process and cure at temperatures far less than clay brick.

Cementatious products can consist of hollow blocks, solid blocks, floor fillers, pavers, architectural products, and other products.

Cementatious products require, in addition to cement and water, an aggregate blend having a certain range of particle sizes in certain percentages. As much as 90% of the dry mixture for cementatious products consists of sand and other aggregate. Typically, sand is used as one of the aggregate materials, along with gravel and other materials.

Foundries also use sand in their operations. One way a foundry uses sand is to form the casting molds. A casting mold is formed of sand and a binder in the exact shape of the part to be cast. The binder can be bentonite clay (which results in green sand) or other proprietary binders. Molten metal is then poured into the sand mold and allowed to harden. After being used, the sand tends to break down, which results in the particle size becoming too fine. As a result, foundries continually must replentish their sand supply with new sand and must discarded the spent sand.

Foundries also use sand for making cores. A core butt are the result of is a portion of sand that is used to make hollow parts within a mold or casting. The core butt consists of sand with a binder (usually an organic binder in conjunction with catalysts) which is used in the center of a casting to displace metal and form a hollow portion. After use, the core butt sand is discarded as well.

Foundries tend to purchase sand with specific particle size based on the type of casting and its requirements. Typically, the spent sand contains particles in the range of 0.6 mm to 0.15 mm, or No. 30 to No. 100 screen sizes. About 5-10 percent of the foundry sand is smaller than 0.075 mm, or No. 200 screen. In general, the sand has low moisture content. However, the sand can have ferrous and organic impurities.

Foundries, therefore, tend to produce spent sand that has a fine particle consistency. This spent sand has traditionally been treated as an industrial waste by foundries. Foundries would dump the spent sand in on-site landfills or have the sand transported off-site. Foundries spend annually a significant amount of money to dispose of spent sand.

The present invention pertains to a method and apparatus for combining a foundry with a cementatious product plant. The spent foundry sand and core butts can be used by the cementatious product plant as aggregate material.

2. Advantages of the Invention

The present invention solves two problems that pertain to foundries and cementatious product plants. Specifically, a problem for foundries is handling, storage, and disposal of spent sand from castings and core butts. An advantage of this invention is that it solves the problems related to spent foundry sand, primarily the need for landfill space.

Another advantage of this invention is that it solves the problems for cementations product plants of acquiring sufficient sand for operation. The cost for sand or other aggregate is a large and significant cost in producing concrete block products.

Another advantage of this invention is that it eliminates the transportation costs involved in moving sand to the cementatious product plant. Transportation costs for sand can be substantial, depending on the distance the sand must be moved. If a cementations product plant is built in tandem with a foundry, the transportation costs are virtually eliminated.

Another advantage is that the foundry can coordinate the handling of the sand waste stream with the concrete product plant, which can reduce storage and other handling costs.

### DESCRIPTION OF THE INVENTION

An average foundry will produce anywhere from a few thousand to hundreds of thousands of tons of spent sand per year. This spent sand comprises casting sand and core butt sand. Foundries typically store the sand in landfills. The spent foundry sand is frequently mixed with scrap metal, slag, uncrushed core butts, and other waste from the foundry operation.

The foundry will also produce significant amounts of slag as well. Slag is glassified silica that has been superheated in the casting process.

Most foundries can expect to spend between $25 to $75 per ton for transportation and disposal of spent sand. Foundry sand must be disposed of in a landfill approved for handling industrial waste of this type. In addition to the transportation cost, there is also a landfill “tipping fee” that the foundry must pay. On the other hand, once the spent foundry sand is manufactured into a cementations product, such as a block, it is no longer considered industrial waste that needs special handling.

Cementatious product manufacturing plants typically consume approximately 25 to 50 thousand tons of sand per year. This sand is used as part of the aggregate material in cementatious products.

Cementatious products are made as follows. A blend is prepared using cement, aggregate and moisture. In addition, pigment can be added to color the blend, and ad mix can be added for to improve the moisture repellency of the product. The cementing ingredient can be cement, fly ash, or other pozzolanics.

The aggregate blend used typically is comprised of coarse aggregates plus sand to give a variety of particle sizes. The aggregate, ideally, should have a predetermined distribution of particle sizes. Industry practice and trial and error have resulted in various suggestions for the distribution of particle sizes for optimum compressive strength and absorption rates in the resulting products.

One typical blend of aggregate is represented in the following table. The table shows the percentage of particles of various sizes. The particle sizes are described by reference to screen numbers, which define particle size by whether the particle can fit through a screen having a certain opening size. The aggregate is sifted through a sequence of screens having progressively smaller openings, and the material that passes through is weighed.

TABLE 1
Typical Aggegate Blend

| Screen | ⅜″ | 4 | 8 | 16 | 30 | 50 | 100 | pan |
|---|---|---|---|---|---|---|---|---|
| % Retained | 0 | 20-30 | 10-22 | 10-20 | 10-20 | 10-20 | 0-15 | 0-10 |

Tables 2-4 are charts showing the particle sizes of typical foundry sand, core butt, and slag. Foundry sand typically has fine gradation. Table 2 is a screen analysis of typical foundry sand. All the foundry sand passed through a No. 30 sieve, with the majority of it being in the 50-100 size.

TABLE 2
Typical Spent Foundry Sand

| Screen | ⅜″ | 4 | 8 | 16 | 30 | 50 | 100 | pan |
|---|---|---|---|---|---|---|---|---|
| % Retained | 0 | 0 | 0 | 0 | 0 | 37 | 53 | 10 |

Table 3 is an analysis of typical core butt sand. Core butt sand is of similar characteristics to foundry sand, with all the particles being larger than 30 size, and most being in the 50-100 range.

TABLE 3
Typical Spent Core Butt Sand

| Screen | ⅜″ | 4 | 8 | 16 | 30 | 50 | 100 | pan |
|---|---|---|---|---|---|---|---|---|
| % Retained | 0 | 0 | 0 | 1 | 0 | 27 | 60 | 11 |

Table 4 is an analysis of typical foundry slag. In addition to the sizes represented below, approximately 4% of the particles were larger than ½″ in size.

TABLE 1
Typical Foundry Slag

| Screen | ⅜″ | 4 | 8 | 16 | 30 | 50 | 100 | pan |
|---|---|---|---|---|---|---|---|---|
| % Retained | 1 | 49 | 36 | 8 | 2 | 1 | 1 | 1 |

The ratio of cement to aggregate is in the range of 1:10 or 1:12.

The final ingredient is moisture, which is typically water. A higher percentage of fine particles and cement typically requires a higher moisture content to maintain a desirable compressive strength in the finished product.

The cementations blend, once completed, can be used in cementatious product manufacturing equipment. This equipment could be housed within a cementatious product plant. There are many manufacturers of such machines, including Zenith Equipment, Besser Industries, and Finlay Block Making Equipment, although those of skill in the art would recognize many other manufacturers of such equipment. These machines take the cementatious mix and place it into a mold corresponding to the type of product desired. Then, the concrete blend is compacted by pressure and vibration. After the concrete sets, the molded products are removed from the mold and transported to a curing environment, which is typically in the temperature range of 120 to 180 degrees Farenheit. Steam may also be used to raise the humidity of the curing chamber.

Aggregate mix is one of the most significant raw material costs for a cementatious product facility. Depending on the part of the country in which the cementatious product plant is located, it may spend between $5 and $20 per ton for field sand, and gravel-type aggregate may cost between $10 and $25 per ton. Although the price for cement is between $80 and $100 per ton, it is used in far lesser quantities than aggregate.

Foundry sand can be used in place of sand in the aggregate mix for cementatious products. The advantage of using foundry sand is its low cost. In fact, foundries pay for disposal of their spent sand. By combining a foundry with a cementatious product plant that is able to utilize foundry sand, both the foundry and the cementations plant save money. The foundry no longer has to pay for sand disposal, and the cementations plant has access to a free source of sand to use as aggregate.

Because of the fine particle size of the foundry sand, it would probably not be feasible to run a cementations product plant with 100% foundry sand. Spent foundry sand can, however, be used as part of the aggregate blend to alleviate disposal problems and to lower raw material cost. To use foundry sand, careful attention must be paid to the particle size distribution in the sand to make sure the resulting blend has a suitable gradation of particle sizes.

The foundry sand will likely need to be amended prior to use in a cementatious blend. This can be done by mixing it with aggregate having the particle sizes that are under-represented in the foundry sand. In the example in Tables 2-3, the foundry sand or core butt sand should be amended by blending it with aggregate having screen sizes in the range of 4-30. This will result in an aggregate having a particle size distribution that results in a product having superior compressive strength and absorption qualities.

One particularly suitable blend consists of 25% foundry sand combined with 50% of 29A gravel and 25% 2NS. It may also be suitable to increase the percentage of foundry sand to as high as 40% when blended with an appropriate gravel-type aggregate like 29A or Type D. Persons of skill in the art will recognize that many different blends incorporating varying percentages of foundry sand can produce suitable results in the finished product. For reasons of economy, it is desirable to use as high a percentage of foundry sand as feasible in the blend.

Problems can occur if the aggregate mix is comprised of too high a percentage of fine particles (smaller than a 30 screen size). In this case, the fine particles require a higher moisture content because they have a larger surface area. Without sufficient moisture, the final product can lose compressive strength. But, as the moisture content of the blend is increased, the mixture loses flowability and becomes gummy to the point that it will not flow through the manufacturing equipment. Fine particle size can also require a higher percentage of cement in the blend, which will increase overall costs.

Slag can also be used, in small quantities, in the cementatious blend to replace the coarse aggregate. The advantage of using slag is that it allows the foundry to dispose of another industrial waste virtually cost free. The slag also gives the finished product a luminescent effect due to the glasslike nature of the slag. Because of the stratified nature of the slag, it may compromise the compressive strength of the resulting product if used in too high a percentage.

To obtain the advantages of the invention, a cementations product facility should be built in tandem with a foundry. This will allow the spent foundry sand to be used by the cementations product facility without incurring outside transportation costs. The sand can be moved from the foundry to the cementatious product plant inexpensively in a variety of ways. For example, off-road haulers or conveyor belt systems could be used to move the spent sand, which can include sand from molds as well as core butts.

One method of transporting the spent sand from the foundry to the cementatious product facility is as follows. The sand is discarded by the foundry via the shake-out area, bag-house, and overflow from the sand storage bins. This sand would typically be on the ground where it could be picked up by a front-end loader and driven a short distance to the cementatious product plant. The spent sand could also be discarded via an overflow chute from a storage bin directly into a dump truck, which could then drive it a short distance to the cementatious product facility. Alternatively, a conveyor belt could be built between the area where sand is discarded and the cementations product plant. All, or combinations of these methods, can economically be used to move sand from the foundry to the cementatious product plant.

The front end loader or dump truck or conveyor belt will deposit the spent sand at a crushing and/or the screening apparatus; this apparatus can be located at either the foundry or the cementations product plant. Before being screened, the core butts must be crushed. After being screened, the sand and/ or slag can be placed into hoppers for storage and subsequent use in the blend.

The present invention can reduce the costs of spent sand handling, storage, and disposal for foundries. The present invention can also reduce the cost of raw materials for the cementatious product facility. Much of the cost attributable to the sand is transportation costs. Trucking companies charge for hauling materials by an hourly rate or by the loaded mile. Hourly rates range from $50 to $75 per hour depending on the truck size. Common truck capacities are 15, 18, and 24 tons. Loaded mile charges range from $1.10 to $2.00 per mile. For example, if a 24 ton dump truck hauls a load of sand 24 miles at 2.00 per mile, the charge will be $480. On a per ton basis, this charge is equal to $20 per ton of sand, which can represent a large percentage of the aggregate cost.

It should be recognized by one of skill in the art that a great many variations in the particulars of implementing this invention can be utilized, all of which are within the scope and spirit of this invention.

I claim:

1. A method of combining a foundry with a cementatious product plant, comprising:
identifying a foundry that produces spent sand;
installing cementatious product manufacturing equipment that uses spent sand one of its raw materials; and,
locating the cementations product manufacturing equipment in proximity to the foundry, such that transportation costs for spent sand from the foundry to the equipment are reduced.

2. The method of claim 1, wherein the cementations product manufacturing equipment is capable of manufacturing blocks.

3. The method of claim 1, wherein the cementatious product manufacturing equipment is capable of manufacturing paver stones.

4. The method of claim 1, comprising the additional step of combining the spent sand with other aggregates for use as an aggregate mix.

5. The method of claim 1, comprising the additional step of transporting the spent sand from the foundry to the cementatious product manufacturing equipment.

6. The method of claim 5, wherein the step of transporting the spent sand from the foundry to the cementations product manufacturing equipment is performed by using a front end loader.

7. The method of claim 5, wherein the step of transporting the spent sand from the foundry to the cementations product manufacturing equipment is performed by using a conveyor belt.

8. The method of claim 5, wherein the step of transporting the spent sand from the foundry to the cementatious product manufacturing equipment is performed by using a dump truck.

9. The method of claim 4, wherein one of the other aggregates comprises slag.
